(19) United States
(12) Patent Application Publication
(10) Pub. No.: US 2007/0226507 A1
(43) Pub. Date: Sep. 27, 2007

(54) Method and System for Depositing Digital Works, A Corresponding Computer Program, and a Corresponding Computer-Readable Storage Medium

(75) Inventor: Peter Schilling, Brandenburg (DE)

Correspondence Address: NORRIS, MCLAUGHLIN & MARCUS, P.A., 875 THIRD AVE, 18TH FLOOR, NEW YORK, NY, 10022, US

(73) Assignee: HOLZWURM GMBH, Brandenburg (DE)

(21) Appl. No.: 11/689,160

(22) Filed: Mar. 21, 2007

Related U.S. Application Data
(60) Provisional application No. 60/785,769, filed on Mar. 24, 2006.

(30) Foreign Application Priority Data
Mar. 22, 2006 (DE) 10 2006 013 991.7

(51) Int. Cl. H04L 9/00

(52) U.S. Cl. 713/176

(57) ABSTRACT

A method and a system for depositing digital works and a corresponding computer program and a corresponding computer-readable storage medium are disclosed, which can be used for depositing digital works under the auspices of an attorney or notary via an encrypted communication link in the Internet. According to the disclosed method, a checksum of the digital work is generated and/or the digital work is provided with a timestamp, optionally by a service provider for a fee. The checksum and/or the digital work signed with a timestamp is registered in an identification document and the identification document is certified and deposited. Preferably, the identification document is certified by a notary, by an attorney or by an institution.

### CROSS-REFERENCE TO OTHER PATENT APPLICATIONS

This application claims the benefit of U.S. provisional Patent Application No. 60/785,769, filed Mar. 24, 2006, the content of which is incorporated herein by reference in its entirety.

### FIELD OF THE INVENTION

The invention relates to a method and a system for depositing digital works, as well as a corresponding computer program and a corresponding computer-readable storage medium, which can be used particularly for depositing digital works under the auspices of an attorney or notary via an encrypted communication link in the Internet.

### BACKGROUND OF THE INVENTION

Digital documents can presently not be deposited notarially, because a prerequisite for a notarial deposit is paper form. Printing a simple music file in paper form fills between one and five standard ring binders and is not suitable for notarial deposition as a legal instrument. Potential legal protection provided by a notarial deposit is therefore denied to authors of digital documents.

It is therefore an object of the invention to provide a method and a system for depositing digital works, as well as a corresponding computer program and a corresponding computer-readable storage medium, which obviate the disadvantages of conventional solutions and more particularly also enables the deposit of digital documents of arbitrary size.

### SUMMARY OF THE INVENTION

The novel deposit method overcomes an obstacle in existence to date for depositing digital documents. This is achieved in that a checksum of the digital work is generated, preferably automatically. Alternatively or in addition, the digital work can also be provided with a timestamp. The checksum and/or the digital work signed with the timestamp is subsequently registered by a notary in an identification document, the identification document is certified and deposited. Registration is preferably performed by registering the public key and the signature of the digital work. The signature and the signed work can also be stored separately. In a particularly advantageous embodiment, the identification document is officially certified by a notary, by an attorney or by an institution. Such institutions can be, for example, business or professional organizations, in particular chambers, public institutions, scientific institutions or persons and associations which are authorized by the aforementioned to provide certification and depositing. The time and the identity of the deposited digital work can be certified more securely if the identification document is also deposited with and/or by a notary, an attorney or an institution. Advantageously, the digital work is stored on a computer-readable storage medium, at the location of the attorney, notary, or institution, or is stored and notarially sealed on a data carrier.

In a preferred embodiment of the method of the invention, a unique, reproducible, irreversible, electronic fingerprint is generated as a checksum. Such unique, irreproducible, irreversible checksum is, for example, a hash value. Several methods are known in the art for generating hash values. More accurate information about such methods for generating hash values are available, for example, in the Internet (see below). In certain situations, it can be advantageous if several methods for generating hash values are cascaded, in that a first hash value of the digital work is generated, a second hash value is generated from the first hash value, and so on. In addition or alternatively, additional (several) fingerprints can be recorded using alternative checksum methods. To more securely verify that the digital work was actually deposited at the specified time, all generated hash values should be noted in the identification document. In addition, additional information about the file of the digital work, the depositor and/or the creator of the digital work can be included in the identification document.

The security of the verification is further increased if the digital work stored on a computer-readable storage medium and the identification document are certified and deposited together, or stored and sealed on a data carrier. Preferably, certification, depositing and sealing are performed by a notary.

According to another preferred embodiment of the method of the invention, the checksum, hash value or other information (e.g., key pairs of a timestamp) for identifying the file of the digital work can be generated on a specially configured data processing system. The data processing system can be implemented as a standalone device, so it need not be manipulated and data can be inputted securely. With suitable secure technology, for example a firewall, encrypted data transmission, the data processing system can also be provided as a server in a data and/or communication network, for example the Internet, so that digital works can be downloaded from a client-computer to the server.

In yet another preferred embodiment of the method of the invention, a special program module is provided for uploading from a client-computer to the server. Preferably, the program module is executed on the client computer. However, the program module may also be installed. In a particularly advantageous embodiment, the program module is implemented as a Java applet and is started on the client-computer by a browser.

The digital works are uploaded to the server with the help of the program module (upload module). Because conventional methods for data transmission of large amounts of data with a browser, for example HTTP, are error-prone, in another preferred embodiment of the invention the file of the digital work is transmitted to the server during upload in several smaller blocks. The upload module hereby calculates a checksum for the digital work stored on the client-computer and transmits this value to the server. Additional information, for example name and/or size of the file, can be determined by the upload module and transmitted to the server. The server then also determines, after concatenation of the uploaded blocks, the hash value and compares this value with the hash value sent from the client-computer. The number of the required upload blocks is determined before transmission of the digital works to the server. This is performed in a preferred embodiment in the upload module. However, this can in principle also be performed on the server.

For uploading or determining the checksum, the hash value and/or a timestamp, it is not necessary to deposit the file of the digital work on a storage device of the data processing system (e.g., the client-computer); as the file can also be supplied to the data processing system from a drive or another data input means on a computer-readable storage medium, such as a CD, DVD, USB flash drive and the like, or via a network, for example the Internet.

According to still another preferred embodiment of the method of the invention, a timestamp process is used for the preferably notarial certification of the digital work. With the timestamp method, a key pair is generated, wherein the key pair includes a public key and a private key, and the digital work is signed with the private key. At least the public key is recorded in an identification document and notarially deposited. The signature or the signed digital work must be stored and can also be notarially deposited. The private key is destroyed after a predetermined duration of validity, preferably after one day.

In order to securely confirm the day the digital work is deposited, in a preferred embodiment of the method of the invention a new key pair is generated daily.

When using the timestamp method, the file of the digital work need not be uploaded to the server, but may remain on the client-computer. Such key pair can then be generated daily by the provider of the method for notarial deposit of digital works as a service. The public key is then deposited with a notary who cooperates with the service provider, whereas the public key can be requested by a customer, who intends to deposit a digital work, for example via the Internet and preferably via a secure link. According to a preferred embodiment of the invention, a program module is also provided to the customer for installation on the customer's computer, and which uses the private key (provided by the server via a secure link) to sign the file of the digital work. This program module also checks the timeliness of the key and make certain that the key can be used only during the defined time period, e.g., 1 day. Preferably, the program module is implemented as an applet in the customer's browser.

The public key can be provided to the customer, instead of via the Internet, also on another data carrier, for example a chip card and the like.

For executing a method for a (preferably notarial) deposit of digital works, a system can be employed which includes at least a data processing system with means for data input and data output. Via these reading means, the digital work is loaded into the data processing system. Any interface can be used for data exchange. In cooperation with a corresponding computer program, the data processing system serves as means for, preferably automated, generation of a checksum for the digital work. In cooperation with another suitable computer program, the at least one data processing system serves as means for automatic generation of a pair consisting of a public and a private key or (optionally in cooperation with again another suitable computer program) as means for automatically signing the digital work by using the private key. In order to be able to notarially deposit the digital work, at least the checksums and/or the public key and/or the signature of the digital work are outputted via means for data output, for example a printer. Checksums and/or the public key are subsequently deposited in the aforedescribed manner in the identification document and notarially deposited.

According to another preferred embodiment of the invention, at least portions of the system for performing a method for (notarially) depositing digital works are connected with the Internet.

According to yet another preferred embodiment of the invention, at least portions of the system for performing a method for (notarially) depositing digital works are used as stand-alone devices, without connections to the Internet. For example, a device is provided which is located at a notary. This device is used for signing the file of the digital work. This device is in the following referred to as signature box. The signature box includes at least

means for reading the digital work into a data processing system,

means for automatically generating a pair of a public key and a private key,

means for automatically signing the digital work using the private key,

means for outputting the public key for (notarially) depositing the public key,

means for outputting the signature of the digital work and/or the signed digital work for storing with the attorney, the notary, the institution, the customer, and/or a service provider.

The file of the digital work is imported into the signature box.

The signature box generates a key pair for the corresponding day.

The signature box signs the file of the digital work.

The signature box prints the public key.

The signature box prints the signature of the digital work.

The public key is in turn deposited with the notary

The signature box ensures that each key pair is valid for only one day.

The method of the invention can be used by a service provider to offer, for a fee, a preferably automatic generation of a checksum for digital works. The generated checksum is provided to a notary who registers the checksum in an identification document, notarizes the checksum and notarially deposits the checksum, optionally with other required measures.

In another use of the system of the invention, a service provider offers, for a fee, to an entity authorized to make a notarized deposit a device (signature box) for, preferably automatic, generation of a checksum of digital works. In this situation, a person entitled to make the notarial deposit can receive digital works directly from the creator of the work without involving the service provider as an intermediary, can enter the digital works into the signature box and compute the associated checksum or sign the file of the digital work with the private key generated by the signature box, output the associated public key as well as the signature of the work, and record the same in the identification document. Moreover, the signed work can be outputted and stored at the notary, the customer or the service provider. This identification document can subsequently be notarially deposited, optionally with the (signed) file of the digital work.

The computer program of the invention enables a data processing system, after the computer program has been loaded into the storage means of the data processing system, to execute a method for (preferably notarial) deposit of digital works, wherein a checksum is generated by the digital work (preferably automatically) and/or the digital work is provided with a timestamp, the checksum and/or the digital work signed with the timestamp is registered in an identification document, and the identification document is (notarially) certified and deposited.

Such computer programs can be provided, for example, (for a fee or free of charge, freely accessible or password-protected) for downloading in a data or communication network, for example from the Internet, to a data processing system connected to the data or communication network.

To execute the deposit method according to the invention, a computer-readable storage medium is employed on which a program is stored which enables a data processing system, after the program has been loaded into the storage means of the data processing system, to execute a method for (preferably notarial) deposit of digital works, wherein a checksum is generated by the digital work (preferably automatically) and/or the digital work is provided with a timestamp, the checksum and/or the digital work signed with the timestamp is registered in an identification document, and the identification document is (notarially) certified and deposited.

In the method of the invention for notarial deposit of digital works, a checksum of the digital work or the public key to be used for authenticating the signature is notarially deposited (if required in paper form). In addition, the signature of the work can also be notarially deposited.

### BRIEF DESCRIPTION OF THE DRAWINGS

Various exemplary embodiments of the invention will now be described in more detail with reference to the appended figure. These depicted embodiments are to be understood as illustrative of the invention and not as limiting in any way.

FIG. 1 shows a schematic flow diagram of the steps of an exemplary deposit of a digital work.

### DETAILED DESCRIPTION OF CERTAIN ILLUSTRATED EMBODIMENTS

The invention will now be described with respect to an example of a notarial deposit of a digital work. This exemplary embodiment, however, should not be viewed as a limitation of the invention. The digital work can also be deposited with other institutions, for example with an attorney, with business or professional organizations, in particular with chambers, or with public institution and persons or associations that have been authorized by the aforementioned institutions for certification and deposit.

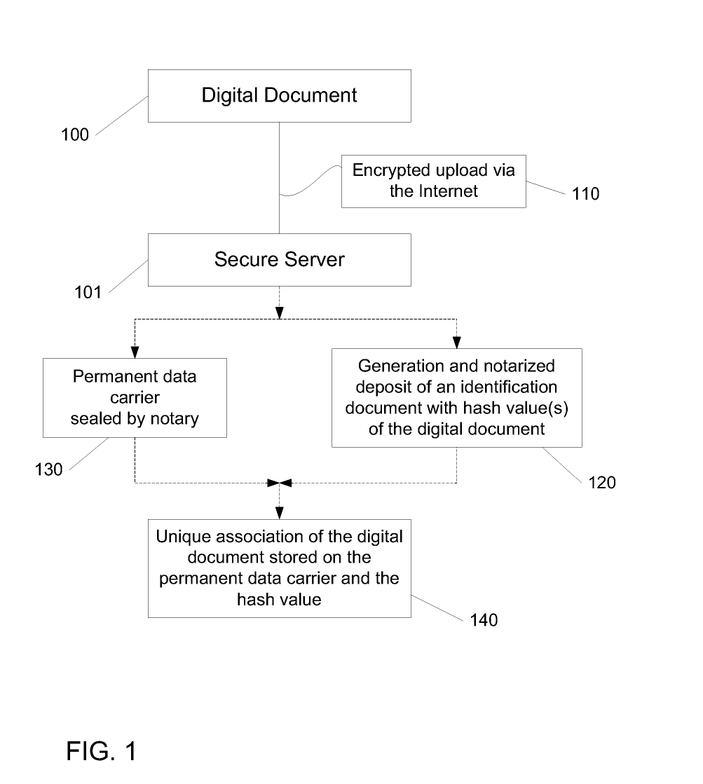

The principle of the deposit provided by the invention will now be briefly described with reference to FIG. 1:

A digital document 100 to be deposited is uploaded by an encrypted upload 110 to a secure server 101 located in the Internet. A program module is installed on the secure server 101, which produces a unique identification pattern of the digital document 100, for example at least one hash value. The identification pattern (the hash value) is used to generate an identification document, wherein the identification pattern (the hash value) is recorded in the identification document and the identification document is subsequently notarially deposited 120. At the same time, the digital document 100 is saved and stored on a permanent data carrier 130. Preferably, this permanent data carrier is also notarially sealed.

The invention enables a notarial deposit of digital documents 100 in practical form 140, because a notarially deposited identification document now exists, if required in paper form, which unambiguously identifies the digital document 100 through the one-to-one association between the identification pattern (the hash value) with the digital document 100.

Other aspects of the invention will now be described in more detail with reference to the following exemplary embodiments. In particular, making a deposit by using a server located in the Internet, but also an example for making a deposit directly with a notary by using a device (signature box) for signing the digitized work and for generating an identification document will be described.

Deposit by using a server in the Internet:

To this end, a program module is provided on a server, preferably a secure server, which can be accessed via a data network or communication network, for example the Internet, wherein the program module generates a unique identification feature, for example a checksum.

In addition, in an exemplary embodiment of the invention, a second program module (upload module) is provided which supports uploading the digital work from the client-computer to the server. This upload module is preferably installed on the client-computer. According to a particularly advantageous embodiment, the upload module can be implemented in a browser as an applet.

Conventionally, uploading is performed without an upload module directly by the browser via HTTP. Depending on the transfer speed and server settings, uploading may be interrupted when transferring large amounts of data. Such transfers are therefore error-prone. A checksum comparison is not performed. Encryption is typically also not performed with these solutions. According to a preferred embodiment of the invention, the digital work is loaded onto the server in several separate blocks, wherein the server subsequently again combines these blocks in a correct upload into the original file. Thereafter, a checksum is generated on the server and compared with the checksum generated from the original file at the client.

Section I: Upload

In the described exemplary embodiment, the customer starts the upload module in a first step with the browser. In a preferred embodiment of the invention, the upload module is a Java applet. This has the advantage that the upload module can run across platforms. Other platform-specific solutions, for example an upload program for Windows™, may also be contemplated.

The customer then selects the file which stores the digital work.

The upload module then computes the checksum, determines the file name and the file size and sends these data to the server.

The client or optionally the server computes the number of required upload blocks, stores the data and sends a request to the upload module to start the upload.

Data blocks are sent one at a time. After upload of the block to the server is complete, the block is linked with the already uploaded data portion, and the server sends a request to the upload module to upload the next block.

After the last block has be uploaded and appended, the checksum is determined at the server and compared with the checksum computed by the client.

If the determined values are not identical, a message is sent to the customer's computer and a new upload is initiated.

If the determined values are identical, then the upload has been successfully completed and can be terminated.

Alternatively, the method can also be executed as follows:

The upload module is started directly on the client's computer, and not in the browser.

Advantageously, the upload module may determine additional data, such as variables about the environment of the transmitting computer, geographic data, personal data and the like.

Advantageously, the data blocks may be concatenated only after the last block has been uploaded.

It may be also advantageous to transmit files in concatenated and/or compressed form.

Through a combined application of hash value methods, such as for example:
MD2, MD4, MD5 (MD=Message Digest Algorithm),
SHA (=Secure Hash Algorithm),
RIPEMD−160 (=RACE Integrity Primitives Evaluation Message Digest),
Tiger,
HAVAL,
Whirlpool.
   a unique, reproducible, irreversible, electronic fingerprint of the digital work can be generated (for more detailed information about the aforementioned methods for generating cash values, reference is made to the following pertinent Internet pages in Wikipedia:
http://de.wikipedia.org/wiki/MD2
http://de.wikipedia.org/wiki/MD4
http://de.wikipedia.org/wiki/MD5
http://de.wikipedia.org/wiki/Secure_Hash_Algorithm
http ://de.wikipedia.org/wiki/RIPEMD−160
http://de.wikipedia.org/wiki/Tiger_%28Hash-Funktion%29
http://de.wikipedia.org/wiki/HAVAL
http://de.wikipedia.org/wiki/Whirlpool_%28Algorithmus%29)

The RFC (=Request For Comments) are listed under http://www.faqs.org/rfcs:
for MD2 RFC1319 under: http://www.faqs.org/rfcs/rfc1319.html
for MD4 RFC1320 under: http ://www.faqs.org/rfcs/rfc1320.html
for MD5 RFC1321 under: http://www.faqs.org/rfcs/rfc1321.html
for Secure_Hash_Algorithm RFC3174 under: http://www.faqs.org/rfcs/rfc3174.html

An identification document is generated for the file of the digital work, which in addition to numerous data for identifying the file and personnel also includes the electronic fingerprint. This identification document or the corresponding information which should be included in the identification document are subsequently transmitted to the notary. This transmission can occur via electronic communication paths, but also conventionally by mail or in person.

The file of the digital work is then preferably copied to a permanent data carrier (CD, DVD, HD, etc.).

The identification document, preferably in paper form, is certified by the notary and deposited. If permitted by law, the identification document can also be deposited in digital form. The data carrier in a protective package (carport, plastic and the like) is labeled by the notary and sealed. Optionally, notarial certification, sealing and deposit or storage of the identification document and/or the file of the digital work can also be performed automatically.

The identification document contains at least one electronic fingerprint generated by a method that is viewed as relatively secure on the day of the deposit. Additional (several) fingerprints generated by alternative checksum methods can also be recorded. Double-hashing is also feasible, whereby another hash value is computed from the hash value of the file.

For file identification, the identification document may further include, for example, at least a portion of the following data:
File name
File description
File size
File origin (IP address)
Information supplied by the client relating to file content
Localization of the file on a sealed data carrier

For identifying the client, the person uploading the file, the creator or owner of the digital work, the identification document may, for example, include at least a portion of the following data
Last name, first name
Mailing address
Date of birth
Country of birth
Passport number
ID card number

According to an alternative embodiment of the method of the invention, the digital work can be signed without upload:

With this method, the file is not uploaded to a server, but remains on the customer's computer.

A key pair is generated in certain time intervals, e.g., daily (however, other time intervals may be contemplated), by a service provider who supports the notarial deposit of digital works, for example by generating signed files and/or documents. The public key is notarially deposited.

An applet in the customer's browser uses the private key which is provided by the server via a secure communication link, and signs the file, in which the digital work is stored, with the private key. The applet also checks the timeliness of the signature and ensures that the signature can only be used during the defined time period, e.g. 1 day.

Comparable techniques of such time stamp methods, however, have certain uncertainties, because misuse of the used token cannot be guaranteed. Unlike the conventional methods, the method of the invention has a significantly higher security level because the key is deposited with a notary.

Another disadvantage of the conventional systems is the required length of the key for long-term keys. Ideally, any possibility for future manipulation should also be eliminated. Attempts have been made to address this problem by using particularly long keys, but this does not offer an effective long-term protection. Conversely, a notarial deposit cannot be manipulated. The advantages of the method of the invention are particularly evident with long-term protection.

Another exemplary embodiment of the invention will now be described with reference to a highly secure server for notarially safeguarding copyrights.

Client software (upload module):

In this exemplary solution, the client software also includes an upload module and is implemented as a conventional desktop application for various operating systems, for example Windows™ or Mac, which are installed by the customer. The software includes all queries to tariffs, file and data sizes, deposit intervals or other conditions, controls authentication of the customer at the highly secure server 101, guarantees unbroken data security during the transfer.

Unlike a browser application, the desktop software requires no other activity from the customer except installation and configuration. The upload 110 to deposited (digital) works 100 occurs automatically in accordance with the configured tariffs and conditions, such as file and data sizes, deposit intervals and the like. While with a browser solution the client always has to become active himself, the desktop software guarantees routine deposits without additional actions by the customer.

The desktop software includes as components two program modules: the user interface and a background service.

The user interface enables the user to configure the background service. The background service transmits in accordance with the user settings, preferably periodically, the data defined by the user (digital document) 102 of the highly secure server. To this end, the service signs and encrypts the data 100 and generates from the data 100 an electronic fingerprint which, in step 110, is transmitted together with the data 100 to the highly secure server 101 in encrypted form. In one exemplary embodiment, a public key of the highly secure server 101 is used for encryption.

The data 100 are decrypted on the highly secure server 101 with the private key of the highly secure server 101. A fingerprint is generated from the customer data and compared with the decrypted transmitted fingerprint. If agreement exists, the deposit procedure begins. The identity of the user is verified by the simultaneously transmitted signature.

The highly secure server 101:

For service provider offering the method of the invention, it is particularly advantageous to operate under a single Web presence with a unified customer message. To this end, the service can also be implemented on external Web addresses and is optimally adapted both with respect to the tariffs and conditions (payment targets, rebates, block sales, bundled, storage, issuance of priority documents, etc.) as well as in the look-and-feel to the specifications of the respective external website. It is hereby required that the programming implemented on the server side is highly variable. It is also advantageous to adapt the server-side programming for different transfer paths (browser, desktop software, safety box) and different deposits (several notaries).

Safety box in closed networks:

According to the invention, a safety box is provided in a closed network without Internet access, for example a company network. The data 100 to be protected are located in this network. The user signs the data with the private key of the user (on a chip card or USB stick or similar medium). The data can optionally also be encrypted with the public key of the company that operates the closed network. The signature and encryption can be implemented with the aforementioned desktop software.

Case 1: the signed (and possibly encrypted) data 100 are transmitted to the safety box. This can be done, for example, by transmitting the data 100 to the safety box via the closed network, or by transferring data from a data carrier, such as CD, DVD, USB memory stick and the like using a drive of the safety box with the data carrier. The box is connected with the Internet and preferably provides the only connection to data processing systems outside the network. In order to transmit the data 100 to be deposited to the highly secure server 101, these data 100 must therefore reside on the safety box. Optionally, the encrypted data 100 are decrypted on the safety box with the private key of the company. With this option, unencrypted, i.e., readable data can be deposited.

A fingerprint of the encrypted or unencrypted data 100 is generated on the safety box. The data 100 are then encrypted with the public key of the highly secure server and transmitted together with the encrypted fingerprint to the highly secure server.

The data 100 are decrypted on the highly secure server with the private key of the highly secure server 101. A fingerprint of the data 100 is generated and compared with the decrypted transmitted fingerprint. If agreement exists, the deposit process begins. The identity of the user is verified by the simultaneously transmitted signature.

Case 2: the signed (and possibly encrypted) data 100 are transmitted to a file server within the closed network. This transmission can be implemented with the aforementioned desktop software. A service runs on the file server which hands the data 100 over to the safety box according to a defined protocol. Optionally, desktop software and server service can communicate with one another for transmitting the data 100 to the file server. Unlike in case 1, a direct network connection hereby exists between the user PC and the file server, and between the file server and the safety box. The safety box has access to the highly secure server 101 located on the Internet.

The steps and options for encryption, verification and further transmission between the safety box and the secure server 101 described with reference to case 1 are performed accordingly.

In another exemplary embodiment, an electronic fingerprint of a) the original file or b) the encrypted original file is already generated at the user location and transmitted to the file server or the safety box. The integrity of the file can be confirmed by once again generating the fingerprint on the safety box.

Another alternative embodiment of the invention includes providing a signature box at the notary.

This signature box can also be provided, for example, by a service provider who supports notarial deposit of digital works.

In this alternative embodiment of the invention, files of the digital works are uploaded by a customer to a server of the service provider, then downloaded by the service provider locally, and subsequently transmitted to the notary (on a data carrier or directly over an encrypted line).

At the notary, the files of the digital works are imported into the signature box. The signature box generates a key pair, preferably as described above a key pair with temporary validity, for example for one day.

The files of the digital works are signed by the signature box and stored on a computer-readable storage medium, for example CD or DVD or a computer-readable storage medium to be developed in the future for these purposes.

The signature box prints the public key. This public key is in turn deposited with the notary. The signature of the work or the signed work is stored by the notary, the client or PriorMart. In a preferred embodiment, the signature box subsequently deletes the file of the digital work and the keys.

The signature box therefore guarantees that each key pair is valid for only one day. In this way, the day of deposit of the digital work is verified.

The function of the signature box can also be certified by an independent institution, for example TÜV, which further enhances the security of the method for deposit.

The stored data can either be stored by the notary or again uploaded to the server of the service provider and made available to the customer.

Embodiments of the invention are not limited to the aforedescribed preferred exemplary embodiments. Instead, a number of variations can be contemplated which in different embodiments make use of the method of the invention and the system of the invention.

What is claimed is:

1. A method for depositing a digital works, comprising the steps of:
generating a checksum of the digital work and/or providing the digital work with a timestamp,
registering the checksum and/or the digital work signed with a timestamp in an identification document and
certifying and depositing the identification document.

2. The method according to claim 1, wherein the identification document is certified by a notary, by an attorney or by an institution.

3. The method according to claim 1, wherein the identification document is deposited with/by a notary, an attorney or an institution.

4. The method according to claim 1, wherein the digital work is stored on a computer-readable storage medium.

5. The method according to claim 1, wherein the checksum is generated automatically.

6. The method according to claim 1, wherein that the checksum comprises a unique, reproducible, irreversible, electronic fingerprint.

7. The method according to claim 1, wherein the checksum comprises a hash value.

8. The method according to claim 7, wherein the hash value is generated by a combination of a hash value methods.

9. The method according to claim 4, wherein the digital work stored on a computer-readable storage medium and the identification document are certified and deposited together.

10. The method according to claim 1, further comprising the step of providing on a client-computer a program module for transmitting the digital work to a remote data processing system for communication between the client-computer and the remote data processing system.

11. The method according to claim 10, wherein the program module is started by a browser on the client-computer or is realized as a desktop application.

12. The method according to claim 10, wherein the digital work is transmitted to the data processing system in several upload blocks, where the number of required upload blocks is determined before the digital work is transmitted to the data processing system.

13. The method according to claim 9, wherein a timestamp is used for certifying the digital work.

14. The Method according to claim 13, further comprising the steps of
providing a pair of keys comprising a private and a public key for certification,
checking timeliness of the private key by an applet installed in the browser of a client, and
signing the digital work depending on the check.

15. The method according to claim 1, further comprising the steps of
creating a digital work within a closed network,
thereafter transmitting the digital work to a first data processing system situated within the closed network,
transmitting the digital work only from this first data processing system to a second data processing system outside the closed network, and
certifying the digital works at the second data processing system.

16. A system for performing a method for depositing a digital work, comprising at least
means for reading the digital work into a data processing system,
means for generating a checksum for the digital work,
means for outputting the checksum for depositing the checksum.

17. The system according to claim 16, wherein the system is connected with the Internet or with a closed network by means for data transmission.

18. A system for performing a method for depositing a digital work, comprising at least
means for reading the digital work into a data processing system,
means for automatically generating a pair of a public and a private key,
means for automatically signing the digital work using the private key,
means for outputting the public key for depositing the public key.

19. The system according to claim 18, wherein the system is connected with the Internet or with a closed network by means for data transmission.

20. A computer-readable storage medium, on which a program is stored which enables a data processing system, after the computer program has been loaded in the memory of the data processing system, to execute a method for depositing a digital work, wherein
a checksum of the digital work is generated and/or the digital work is provided with a timestamp,
the checksum and/or the digital work signed with a timestamp is registered in an identification document, and
the identification document is certified and deposited.

21. A process for depositing digital works, comprising the steps of:
offering generation of a checksum of digital works and/or signing of the digital work with
a timestamp through a service provider for a fee,
registering the generated checksum and/or the digital work signed with a timestamp in an identification document, and
certifying and depositing the identification document.

22. The process according to claim 21, further comprising the step of providing a person authorized to make the deposit with a device for generating a checksum of digital works, said device provided by a service provider for a fee.

23. The process according to claim 22, wherein the device is a certified device.
